(19) United States
(12) Patent Application Publication
(10) Pub. No.: US 2017/0369369 A1
(43) Pub. Date: Dec. 28, 2017

(54) ANTIMICROBIAL CHEMICALLY STRENGTHENED GLASS AND METHOD FOR THE MANUFACTURE THEREOF

(71) Applicant: KORNERSTONE MATERIALS TECHNOLOGY COMPANY, LTD., FUZHOU, FUJIAN (CN)

(72) Inventors: JACK Y. DING, FUZHOU, FUJIAN (CN); ERIC CHAN, TAOYUAN CITY, TAIWAN (CN); WEIWEI ZHANG, FUZHOU CITY, FUJIAN (CN)

(21) Appl. No.: 15/528,918

(22) PCT Filed: Feb. 12, 2015
(86) PCT No.: PCT/CN2015/072914

§ 371 Date: May 23, 2017

(51) Int. Cl. C03C 21/00; C03C 3/085; C03C 4/18

(52) U.S. Cl. CPC C03C 21/005; C03C 4/18; C03C 3/085; C03C 2204/02

(57) ABSTRACT

An antimicrobial chemically strengthened glass and a method for manufacturing the antimicrobial glass article. The antimicrobial chemically strengthened glass is suitable for use as high-strength cover glass for touch displays.

### FIELD OF THE INVENTION

The present invention relates to an antimicrobial chemically strengthened glass and a method for manufacturing the chemically strengthened antimicrobial glass.

### BACKGROUND

As a consequence of rapid industrial growth, environmental disruption and disease have become more and more of a concern. Especially in recent years, the threat of SARS, Ebola and bird flu have raised awareness of the need for cleanliness and personal hygiene. As touch technologies proliferate, consumers are becoming increasingly aware of the possible existence of bacteria on mobile devices, particularly as touch-enabled surfaces are increasingly shared at home, work, and elsewhere. Therefore, there is an urgent need to develop effective and low cost cover glass that has antimicrobial properties.

Silver has long been known for its excellent antimicrobial properties; however, silver is relatively expensive and consequently cannot be fully utilized in industrial glass production. Most conventional antimicrobial glass has an antimicrobial layer of silver on the glass surface. Several methods are used to form this layer such as by adding silver to the raw materials for forming the glass, using silver salt spray pyrolysis, adding silver to the ion-exchange bath, coating the glass with silver, vacuum sputtering with silver and sol-gel processes for forming silver doped hybrid silicon dioxide transparent thin films from solutions that include silver nitrate and tetraethyl orthosilicate. Among such methods, adding silver to the ion-exchange bath is the most common and is the most likely technique to be used for mass production of glass having antimicrobial properties. Conventional ion exchange processes are used to chemically strengthen glass substrates and typically involve placing the glass in a molten salt containing ions having a larger ionic radius than ions present in the glass, such that the smaller ions present in the glass are replaced by larger ions from the molten salt solution. Typically, potassium ions in the molten salt replace smaller sodium ions present in the glass. The replacement of the smaller sodium ions present in the glass by larger potassium ions from the heated solution results in the formation of a compressive stress layer on both surfaces of the glass and a central tension zone sandwiched between the compressive stress layers. The tensile stress (“CT”) of the central tension zone (typically expressed in megapascals (MPa)) is related to the compressive stress (“CS”) of the compressive stress layer (also typically expressed in megapascals), and the depth of the compressive stress layer (“DOL”) by the following equation:

CT=CS×DOL/(t−2DOL)

wheret is the thickness of the glass.

Conventional ion exchange methods for making glass having antimicrobial properties include a one-step method in which silver is added to the conventional ion exchange bath. Glass produced by the one-step ion exchange method, however, has certain disadvantages such as silver colloidization which lowers the transmittance of visible light, low antimicrobial efficacy due to a low concentration of silver on the surface of the glass, and significant amounts of silver which reside in a deep ion exchange layer of the glass that has no effect on the antimicrobial properties of the glass.

Glass that simply incorporates silver as a component of the batch materials used to form the ion-exchangeable glass also has shortcomings. Specifically, the glass that results from such batch materials will have a low concentration of silver on the glass surface and will therefore have poor antimicrobial properties. If attempts are made to overcome this problem by including a high concentration of silver in the batch materials, the glass that results will have a visible yellow color and will have reduced antimicrobial properties due to silver colloidization caused by the high temperature ion exchange process which will lead to a decrease in the glass transmittance.

### DETAILED DESCRIPTION

In several exemplary embodiments, the present invention provides chemically strengthened glass having antimicrobial properties and methods for making the chemically strengthened glass. The chemically strengthened glass has particular application as an antimicrobial cover glass for electronic displays, touch displays such as smart phones, tablets, notepads and automated teller machines, vehicle windshields and architectural structures. The chemically strengthened glass can also be used in household goods that would benefit from having antimicrobial properties such as baby bottles and glassware. As used herein the term “antimicrobial” refers to a material that has one or more of antibiotic, antibacterial, antifungal, antiparasitic and antiviral properties.

According to several exemplary embodiments, the chemically strengthened glass having antimicrobial properties is produced from an ion exchangeable glass composition that includes:
from about 50.0 to about 78.0 weight percent (wt %) of silicon dioxide (SiO₂),
from about 1.0 to about 25.0 wt % of aluminum oxide (Al₂O₃),
from about 0.0 to about 26.0 wt % of boron trioxide (B₂O₃),
from about 4.0 to about 30.0 wt % of R₂O, wherein R=Li⁺, Na⁺, K⁺; and
from about 0.1 to about 18.0 wt % of R′O, wherein (R=Ca²⁺, Mg²⁺, Sr²⁺, Ba²⁺).

According to several exemplary embodiments, the chemically strengthened antimicrobial glass has a surface concentration of at least 1 wt % of silver ion and at least 1 wt % of copper ion. According to several exemplary embodiments, copper has been found to have beneficial antimicrobial properties due to its ability to exist in three valence states, namely Cu⁰, Cu¹⁺ and Cu²⁺.

According to several exemplary embodiments, the chemically strengthened antimicrobial glass is capable of inhibiting at least 2 microbial species to an antimicrobial efficacy of greater than 99% within 24 hours. According to several exemplary embodiments, the microbial species include Escherichia coli and staphylococcus aureus.

According to several exemplary embodiments, the chemically strengthened antimicrobial glass is produced by methods that include a two-step ion exchange process in which silver is incorporated in a first step and copper is incorporated in a second step to result in a chemically strengthened antimicrobial glass that incorporates a relatively small amount of silver together with copper to overcome the glass coloring problem inherent with the use of silver alone and to reduce the cost of production of the chemically strengthened antimicrobial glass.

According to several exemplary embodiments, the method for manufacturing chemically strengthened antimicrobial glass includes a two-step ion exchange process for introducing silver and copper ions into the glass to provide the glass with antimicrobial properties. According to several exemplary embodiments, the two-step process utilizes a first ion-exchange bath that includes potassium nitrate (KNO₃) and silver nitrate (AgNO₃), followed by a second ion-exchange bath that includes KNO₃ and copper compounds such as copper chloride (CuCl₂) and copper sulfate (CuSO₄).

According to several exemplary embodiments, the first step of the ion-exchange process is conducted in an ion-exchange bath that includes a molten silver salt for a time period of from 5 minutes, 10 minutes or 20 minutes to 1 hour, 2 hours or 4 hours at a temperature of from 380° C. to 500 ° C. According to several exemplary embodiments, the first step of the ion-exchange process is conducted in an ion-exchange bath that includes from 0 wt % or 0.005 wt % to 10 wt %, 20 wt % or 30 wt % of a molten silver salt. According to several exemplary embodiments, the first step of the ion-exchange process is conducted in an ion-exchange bath that includes molten silver nitrate.

According to several exemplary embodiments, the second step of the ion-exchange process is conducted in an ion-exchange bath that includes a molten copper salt for a time period of from 5 minutes, 10 minutes or 20 minutes to 1 hour, 2 hours or 4 hours at a temperature of from 380° C. to 500° C. According to several exemplary embodiments, the second step of the ion-exchange process is conducted in an ion-exchange bath that includes from 0 wt % or 0.005 wt % to 10 wt %, 20 wt % or 30 wt % of a molten copper salt. According to several exemplary embodiments, the second step of the ion-exchange process is conducted in an ion-exchange bath that includes one or more of molten copper sulfate, copper chloride or copper nitrate.

According to several exemplary embodiments, the first step of the ion-exchange process that utilizes the ion-exchange bath that includes silver nitrate is conducted for a shorter time than the second step of the ion-exchange process that utilizes the ion-exchange bath that includes a copper compound. According to several exemplary embodiments, the first step of the ion-exchange process is conducted for a time period of less than one hour at a temperature in the range of from 380° C. to 500° C. According to several exemplary embodiments, the second step of the ion-exchange process is conducted for a time period of more than one hour at a temperature in the range of from 380° C. to 500° C., so that a higher concentration of copper ions are exchanged into the surface of the glass to replace the alkali metal ions in the glass.

According to several exemplary embodiments, the method for manufacturing chemically strengthened antimicrobial glass includes a one-step ion exchange processin which silver and copper ions are introduced at the same time to form chemically strengthened glass having antimicrobial properties. According to several exemplary embodiments, the one-step ion exchange process utilizes an ion-exchange bath that includes silver molten salt, copper molten salt and KNO₃ molten salt. According to several exemplary embodiments, the one-step ion exchange method is conducted for a time period of from 1 hour or 2 hours to 6 hours, 8 hours or 10 hours. According to several exemplary embodiments, the one-step ion exchange method is conducted at a temperature of from 380° C. to 500° C. According to several exemplary embodiments, the one-step ion exchange method is conducted in an ion-exchange bath that includes a mass ratio of silver ions to copper ions of from 0.005 to 1. According to several exemplary embodiments, the one-step ion exchange method is conducted in an ion-exchange bath that includes a mass ratio of silver ions to copper ions of from 0.05 to 0.8. According to several exemplary embodiments, the one-step ion exchange method is conducted in an ion-exchange bath that includes a mass ratio of silver ions to copper ions of from 0.1 to 0.5.

According to several exemplary embodiments, the method for manufacturing an antimicrobial glass includes utilizing one or a combination of adding Ag ions and Cu ions to the raw materials for forming the glass, spray pyrolysis of molten Ag salt and Cu salt, ion exchange in an ion-exchange bath comprising Ag salt and Cu salt, coating with Ag and Cu, vacuum sputtering with Ag and Cu, and sol-gel for forming an Ag and Cu doped hybrid silicon dioxide transparent film, to ensure a surface concentration of at least one wt % of silver ions and at least one wt % of copper ions.

The following examples are illustrative of the compositions and methods discussed above.

### EXAMPLE 1

According to Example 1, seven glass samples were made from a glass composition that included 64 wt % of silicon dioxide (SiO₂), 16 wt % of aluminum trioxide (Al₂O₃), 14 wt % of sodium oxide (Na₂O), 4 wt % of magnesium oxide (MgO), 0.5 wt % of tin oxide (SnO), and 1.5 wt % of oxides of iron, calcium, potassium, zirconium, boron, lithium and strontium. The samples were cut into glass slides of 5 cm×5 cm square and placed in a high temperature furnace. The temperature of the glass slides was increased from room temperature to 350° C. in 1 hour. After that, the glass slides were removed from the furnace and ion exchanged as follows:
Sample 1—20 minutes in a first ion exchange bath at a temperature of 420° C. wherein the first ion exchange bath included 2% by weight of molten AgNO₃ and 98% by weight of molten KNO₃;
Sample 2—20 minutes in a first ion exchange bath at a temperature of 420° C. wherein the first ion exchange bath included 5% by weight of molten AgNO₃ and 95% by weight of molten KNO₃;
Sample 3—20 minutes in a first ion exchange bath at a temperature of 420° C. wherein the first ion exchange bath included 2% by weight of molten AgNO₃ and 98% by weight of molten KNO₃ and then 1 hour in a second ion exchange bath at a temperature of 420° C. wherein the second ion exchange bath included 5% by weight of molten CuCl₂ and 95% by weight of molten KNO₃;
Sample 4—20 minutes in a first ion exchange bath at a temperature of 420° C. wherein the first ion exchange bath included 5% by weight of molten AgNO₃ and 95% by weight of molten KNO₃ and then 1 hour in a second ion exchange bath at a temperature of 420° C. wherein the second ion exchange bath included 5% by weight of molten CuCl₂ and 95% by weight of molten KNO₃;
Sample 5—20 minutes in a first ion exchange bath at a temperature of 420° C. wherein the first ion exchange bath included 2% by weight of molten AgNO₃ and 98% by weight of molten KNO₃ and then 1 hour in a second ion exchange bath at a temperature of 420° C. wherein the second ion exchange bath included 5% by weight of molten CuSO₄ and 95% by weight of molten KNO₃;
Sample 6—20 minutes in a first ion exchange bath at a temperature of 420° C. wherein the first ion exchange bath included 5% by weight of molten AgNO₃ and 95% by weight of molten KNO₃ and then 1 hour in a second ion exchange bath at a temperature of 420° C. wherein the second ion exchange bath included 5% by weight of molten CuSO₄ and 95% by weight of molten KNO₃; and
Sample 7—This sample was a control blank that was not ion exchanged.

In each case, following the ion exchange process or in the case of the control blank following removal from the high temperature furnace, the glass slides were transferred to an annealing furnace and were cooled to 80° C. in 1 hour. The glass slides were then washed five times with distilled water.

The glass slides were then analyzed by energy-dispersive X-ray spectroscopy to conduct an elemental analysis of the glass slides and to determine the surface concentration of silver ions and copper ions.

The results are shown in Table 1 below.

TABLE 1

| | Molten Salt | Surface Concentration/EDS | |
|---|---|---|---|
| Samples | Concentration | Ag/wt % | Cu/wt % |
| 1 | 2% AgNO₃ | 18.8 | 0 |
| 2 | 5% AgNO₃ | 22.5 | 0 |
| 3 | 2% AgNO₃ + 5% CuCl₂ | 3.1 | Not Detected |
| 4 | 5% AgNO₃ + 5% CuCl₂ | 4.4 | Not Detected |
| 5 | 2% AgNO₃ + 5% CuSO₄ | 3.9 | 1.8 |
| 6 | 5% AgNO₃ + 5% CuSO₄ | 5.9 | 1.4 |
| 7 | Blank | 0 | 0 |

As tested by SEM-EDS, the ion-exchanged depth of Ag is approximately 40-50 μm, and that of Cu is approximately 30 μm. Consequently, the surface concentration of Ag and Cu calculated from the volume concentration data set forth in Table 1 is approximately 0.05-100 μg/cm².

Also in addition to the concentrations of the silver ion and copper ion at the surface of the glass samples, sample 2 turned yellow after a one-step ion exchange process in which the ion-exchange bath included 5wt % molten AgNO₃but in contrast, sample 5 was almost transparent after a two-step ion exchange process, in which the first ion-exchange bath included 2wt % molten AgNO₃and the second ion-exchange bath included 5 wt % CuSO₄.

### EXAMPLE 2

The antimicrobial efficacy of theion-exchanged glass samples produced in accordance with Example 1 above was evaluated according to the following process.

Escherichia coli and staphylococcus aureus were cultivated and the cultures were transferred to nutrient agar medium and incubated for 24 hours at 37° C. The cell cultures were then diluted ten times to a final bacterial concentration of approximately (5-10)×105 colony-forming units per milliliter (cfu/mL). Next, 0.3 mL bacteria droplets were placed on the selected glass surface (A, petri dish plate), untreated specimen (B, the control) or treated specimen (C).

The cell suspension was placed onto each sample surface and held in close contact by using a sterilized laboratory parafilm (thickness:0.05 mm), and was incubated for 24 hours at 37° C., at relative humidity (RH) >90%. Each sample was produced in triplicate. After 24 hours of incubation, 2 ml of normal saline (adding 0.2% Tween 80) was added into each Petri dish. After shaking, both the slide and parafilm were washed, and 0.4 ml of solution was collected from each Petri dish and placed onto an agar plate. After a further 24-48 hour incubation at 37° C., the bacteria colony formation on the agar plate was examined.

The antimicrobial activity of a glass sample was calculated in accordance with the Chinese JC/T 1054-2007 coated antibacterial glass standard using the following equation:

R%=(B−C)/B×100

Where R is antimicrobial efficacy; B is the number of bacterial colonies from an untreated specimen in terms of colony-forming units per petri dish or specimen (cfu/pc) and C is the number of bacterial colonies from a treated control specimen (cfu/pc); the three parallel number of bacteria colonies from the same untreated specimen (B) is :

Maximum log−Minimum log/average number of colonies <0.3.

The results are shown in Table 2 below.

TABLE 2

| | Molten Salt | Surface Concentration/EDS | | Average | Antimicrobial |
|---|---|---|---|---|---|
| Samples | Concentration | Ag/wt % | Cu/wt % | Colonies | Efficacy |
| 1 | 2% AgNO₃ | 18.8 | 0 | 1 | 98% |
| 2 | 5% AgNO₃ | 22.5 | 0 | 0 | 100% |
| 3 | 2% AgNO₃ + 5% CuCl₂ | 3.1 | Not Detected | 18 | 67% |
| 4 | 5% AgNO₃ + 5% CuCl₂ | 4.4 | Not Detected | 13 | 76% |
| 5 | 2% AgNO₃ + 5% CuSO₄ | 3.9 | 1.8 | 0 | 100% |
| 6 | 5% AgNO₃ + 5% CuSO₄ | 5.9 | 1.4 | 5 | 91% |
| 7 | Blank | 0 | 0 | 55 | — |

With respect to the antimicrobial efficacy of the samples shown in Table 2 and as noted above, Samples 1 and 2 were ion exchanged by a one-step method in which the ion-exchange bath included AgNO₃; Samples 3 and 4 were ion exchanged by a two-step method in which the first ion-exchange bath included AgNO₃ and the second ion-exchange bath included CuCl₂; and Samples 5 and 6 were ion exchanged by a two-step method in which the first ion-exchange bath included AgNO₃ and the second ion-exchange bath included CuSO₄.

As shown by the results in Table 2, the antimicrobial glass produced according to the present invention is an efficient antimicrobial glass. Samples 3, 4, 5 and 6 in Table 2 have a surface silver ion concentration of from 3.1 wt % to 5.9 wt % while Samples 5 and 6 also have a surface copper ion concentration of from 1.4 wt % to 1.8 wt %. The results shown in Table 2 demonstrate that samples 5 and 6, which have a surface silver ion concentration of from 3.9 wt % to 5.9 wt % and a surface copper ion concentration of from 1.4 wt % to 1.8 wt %, have a high antimicrobial efficiency much like samples 1 and 2. However, unlike samples 1 and 2 which turn yellow because of a high silver concentration on the surface, samples 5 and 6 are transparent.

While the present invention has been described in terms of certain embodiments, those of ordinary skill in the art will recognize that the invention can be practiced with modification within the spirit and scope of the appended claims.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

The present disclosure has been described relative to certain embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A chemically strengthened antimicrobial glass having a surface concentration of at least one wt % of silver ions and at least one wt % of copper ions.

2. The antimicrobial glass, according to claim 1, wherein the glass has a composition comprising:
from about 50.0 to about 78.0 wt % of SiO₂;
from about 1.0 to about 25.0 wt % of Al₂O₃;
from about 0.0 to about 26.0 wt % of B₂O₃;
from about 4.0 to about 30.0 wt % of R₂O, wherein R=Li⁺, Na⁺, K⁺; and
from about 0.1 to about 18.0 wt % of R′O, wherein (R′=Ca²⁺, Mg²³⁰ , Sr²⁺, Ba²⁺).

3. The antimicrobial glass, according to claim 1, wherein the glass is capable of inhibiting at least 2 microbial species to antimicrobial efficacy of greater than 99% within 24 hours.

4. The antimicrobial glass, according to claim 3, wherein the microbial species comprises to Escherichia coli and staphylococcus aureus.

5. A method of making an antimicrobial glass article, comprising:
depositing an ion-exchangeable glass article in a first ion-exchange bath comprising a molten silver salt for 5 minutes to 4 hours at a temperature of from 380° C. to 500° C.;
removing the ion-exchangeable glass article from the first ion-exchange bath; and
depositing the glass article in a second ion-exchange bath comprising a molten copper salt for 5 minutes to 4 hours at a temperature of from 380° C. to 500° C.

6. The method of making an antimicrobial glass article according to claim 5, wherein the first ion-exchange bath comprises molten silver nitrate.

7. The method of making an antimicrobial glass article according to claim 5, wherein the glass article is deposited in the first ion-exchange bath for 10 minutes to 2 hours.

8. The method of making an antimicrobial glass article according to claim 5, wherein the glass article is deposited in the first ion-exchange bath for 20 minutes to 1 hour.

9. The method of making an antimicrobial glass article according to claim 5, wherein the weight percent of the molten silver salt in the first ion-exchange bath is from 0 to 30%.

10. The method of making an antimicrobial glass article according to claim 5, wherein the weight percent of the molten silver salt in the first ion-exchange bath is from 0 to 20%.

11. The method of making an antimicrobial glass article according to claim 5, wherein the weight percent of the molten silver salt in the first ion-exchange bath is from 0.005% to 10%.

12. The method of making an antimicrobial glass article, according to claim 5, wherein the second ion-exchange bath comprises a copper salt selected from the group consisting of copper sulfate, copper chloride and copper nitrate.

13. The method of making an antimicrobial glass article, according to claim 5, wherein the glass article is deposited in the second ion-exchange bath for 10 minutes to 2hours.

14. The method of making an antimicrobial glass article, according to claim 5, wherein the glass article is deposited in the second ion-exchange bath for 20 minutes to 1 hour.

15. The method of making an antimicrobial glass article, according to claim 5, wherein the weight percent of the molten copper salt in the second ion-exchange bath is from 0 to 30%.

16. The method of making an antimicrobial glass article, according to claim 5, wherein the weight percent of the molten copper salt in the second ion-exchange bath is from 0 to 20%.

17. The method of making an antimicrobial glass article, according to claim 5, wherein the weight percent of the molten copper salt in the second ion-exchange bath is from 0.005% to 10%.

18. A method of making an antimicrobial glass article, comprising ion-exchanging an ion-exchangeable glass article in a molten salt ion-exchange bath comprising Ag ions, Cu ions and KNO₃ for 1 hour to 10 hours at a temperature of from 380° C. to 500° C.

19. The method of making an antimicrobial glass article, according to claim 18, wherein the ion-exchange bath comprises a mass ratio of Ag ions to Cu ions of from 0.005 to 1.

20. The method of making an antimicrobial glass article, according to claim 18, wherein the ion-exchange bath comprises a mass ratio of Ag ions to Cu ions of from 0.05 to 0.8.

21. The method of making an antimicrobial glass article, according to claim 18, wherein the ion-exchange bath comprises a mass ratio of Ag ions to Cu ions of from 0.1 to 0.5.

22. The method of making an antimicrobial glass article, according to claim 18, wherein the ion-exchange time is from 1 hour to 8 hours.

23. The method of making an antimicrobial glass article, according to claim 18, wherein the ion-exchange time is from 2 hours to 6 hours.

24. A method of making an antimicrobial glass article, comprising utilizing at least one of, adding Ag ions and Cu ions to the raw materials for forming the glass, spray pyrolysis of molten Ag salt and Cu salt, ion exchange in an ion-exchange bath comprising Ag salt and Cu salt, coating with Ag and Cu, vacuum sputtering with Ag and Cu, and sol-gel for forming an Ag and Cu doped hybrid silicon dioxide transparent film, to ensure a surface concentration of at least one wt % of silver ions and at least one wt % of copper ions.
